(19) United States
(12) Patent Application Publication
(10) Pub. No.: US 2006/0286207 A1
(43) Pub. Date: Dec. 21, 2006

(54) STABILIZATION OF MALT-BASED AND HOPS-BASED PRODUCTS

(76) Inventor: Kimberley H. Gray, Loveland, OH (US)

Correspondence Address: FROST BROWN TODD, LLC, 2200 PNC CENTER, 201 E. FIFTH STREET, CINCINNATI, OH, 45202, US

(21) Appl. No.: 11/423,738

(22) Filed: Jun. 13, 2006

Related U.S. Application Data
(60) Provisional application No. 60/690,205, filed on Jun. 14, 2005.

(51) Int. Cl. C12C 11/00

(52) U.S. Cl. 426/16

(57) ABSTRACT

Malt-based or hops-based beverage products, such as beer, ale, malt coolers and malternatives, are disclosed. These compositions contain a stabilizing mixture comprising a metal (in the form of ions, salts or oxides) such as zinc or magnesium, either alone or together with an adjunct component such as ascorbic acid. These beverage products do not form off-flavors when they are exposed to sunlight or fluorescent light. This provides for more efficient and inexpensive manufacture of the products, makes the products easier to ship, and eliminates the need for expensive opaque packing materials.

This application is based upon and claims priority from U.S. Provisional Application No. 60/690,205, filed Jun. 14, 2005, incorporated herein by reference.

### BACKGROUND OF THE INVENTION

Malt-based and hops-based beverages, such as beer, have been brewed and consumed since ancient times and are the subject of a growing popularity today. The beer market is now a global market affording wide geographical availability of beers from many countries. It is very easy now to walk into a restaurant or store in the United States and order a beer made in, for example, Belgium, Germany, Canada, Mexico, Japan or India, as well as a very wide variety of American-made beers from small breweries, as well as large breweries. In addition to products made by large breweries, there are a growing number of beers made by small “designer” breweries. From its consumption at sporting events to gourmet beer tastings, and all points in between, the worldwide popularity of beer is growing. The global market, which requires shipping and availability of beers around the world, makes the shelf-stability of beer particularly important.

At the same time, flavored non-beer malt-based alcoholic beverages (the so-called “malternatives”) are growing rapidly in popularity. These beverages, such as MIKE'S® Hard Lemonade or SMIRNOFF® ICE®, tend to attract a younger audience, because they do not have the “bite” (e.g., the bitter taste) which hard liquor beverages frequently have.

Malt-based products and hops-based products are susceptible to off-flavor formation when they are exposed to sunlight, ultraviolet or fluorescent light. The off-flavor in hopped beers results from the photodegradation of isohumulones into 3-methylbut-2-ene-1-thiol. C. S. Burns, A. Heyerick, D. de Keukeleire, M. D. E. Forbes, Chem. Eur. J. 2001, 7(21):2553-4561.

Current efforts to address this issue include packaging beer in dark bottles or the use (for example, by Miller Brewing Company) of specialized hops (tetra-hydro-iso-alpha acids) which avoid this reaction. Malt extract is also known to be a source of sulfur-containing compounds and proteins that undergo photochemical reactions to produce off-flavors.

The present invention provides a cost-effective way to prevent or minimize the formation of off-flavors, caused by exposure to light, in malt-based and/or hops-based beverage products. These products include beer, ale, light beer, malt liquor, lager, lambic, malted beverages (alcoholic and nonalcoholic), malt coolers, and malternatives (flavored non-beer malt-based alcoholic beverages).

Dairy-based beverages, although a different type of beverage, are also known to undergo off-flavor formation when exposed to ultraviolet or fluorescent light. That off-flavor formation is thought to result from one of two mechanisms: (1) lipid oxidation; or (2) riboflavin-catalyzed degradation of milk amino acids (i.e., photo-oxidation of methimine to methional). A number of approaches have been suggested to address off-flavor formation in beverages, for example dairy-based beverage products.

Japanese Published Patent Application 2000228952, Hiroshi et al., published Aug. 22, 2000, describes the addition of vitamin E (tocopherol), at from 5 to 5000 ppm, to a milk-containing beverage to prevent the generation of off-flavors.

U.S. Published Patent Application 2003/0129403, Beaverson et al., published Jul. 10, 2003, describes odor-absorbent packaging which is made from a resin and includes, within that resin, cyclodextrin and nanosized zinc particles. The packaging is specifically taught to absorb light-induced off-flavors in milk products. The approach taken by this reference is to be contrasted with that of the present development in that the described packaging does not prevent the formation of the odors as does the present development, rather it ties up the odors after they are formed. The application teaches that it is preferred that the metal particles contained in the resin be substantially free of their oxide compounds. PCT Publication WO 93/10174 is cited as describing a thermoplastic film which contains aluminum, magnesium, manganese or zinc powder.

U.S. Pat. No. 5,888,563, Mehansho et al., granted Mar. 30, 1999, describes a milk- or soy-based beverage which is formulated to minimize off-flavors caused by the inclusion of mineral supplements, such as iron. The beverage utilizes an emulsifier capable of forming a bilayer structure to provide the desired result. Iron fumarate and zinc fumarate are among the supplements included in the beverages. Example III describes a milk-based beverage which contains iron, zinc and ascorbic acid; the levels and proportions used of these materials are not disclosed in the example.

U.S. Published Patent Application 2003/0194468, Konkoly et al., published Oct. 16, 2003, describes a method for producing a nutritionally fortified dairy beverage. The application teaches the inclusion of vitamins and minerals at dietary supplement levels in the beverage. The beverage is a yogurt-based cultured dairy beverage.

U.S. Published Patent Application 2002/0155194, Mehansho et al., published Oct. 24, 2002, describes stabilizing dairy compositions which utilize arabinogalactan to provide fiber and to stabilize the composition. The application teaches that the inclusion of some minerals (for example, iron) can lead to the formation of off-flavors in the compositions. It is taught that the compositions may be fortified with vitamins and minerals at supplementation levels.

U.S. Pat. No. 5,529,926, Maat, granted Jun. 25, 1996, describes a DNA sequence for a polypeptide having sulfhydryl oxidase (SOX) activity. It is taught that this polypeptide can be used to remove the burnt flavors during the ultrahigh temperature sterilization of milk.

Combinations of metals (for example, zinc or magnesium) with ascorbates, erythorbates or sugar alcohols have been disclosed for use to stabilize dairy-derived beverage products. See U.S. patent application Ser. No. 11/011,642, Gray et al., filed Dec. 14, 2004.

### SUMMARY OF THE INVENTION

The present invention relates to malt-based or hops-based beverages comprising:

(a) a malt-based or hops-based liquid beverage base; and

(b) a stabilizing mixture comprising:
i. from about 0.000001% to about 0.2% (based on the weight of the beverage, preferably from about 0.000001% to about 0.1%) of a metal (in the form of ions, metal compounds, oxides, complexes, chelates, or nonionic forms) selected from zinc, magnesium, calcium, chromium, copper, iron, selenium, manganese, and combinations thereof; and
ii. from about 0.01% to about 2.5% (preferably from about 0.01% to about 1.5%) of an adjunct component selected from ascorbic acid, erythorbic acid, ascorbates, erythorbates, sugar alcohols, and combinations thereof.

Preferred metals (present in the form of ions or compounds) include zinc, magnesium and manganese, and preferred adjunct components include ascorbic acid and inositol.

The present invention also relates to malt-based or hops-based beverage products comprising:

(a) a malt-based or hops-based beverage base; and

(b) from about 0.000001% to about 0.2% (preferably from about 0.000001% to about 0.1%) of a metal (present in the form of ions, metal compounds, oxides, complexes, chelates, or nonionic forms) selected from zinc, magnesium, calcium, chromium, copper, iron, selenium, manganese, and combinations thereof. Preferred metals include zinc, magnesium and manganese.

The beverage products of the present invention will generally be selected from beer, ale, light beer, malt liquor, lager, lambic, malted beverages (both alcoholic and nonalcoholic), malt coolers, and malternatives.

All percentages and ratios noted herein are “by weight” unless otherwise specified. As used in the claims, the percentages for the “metals” component are based on the weight of the metals themselves, not the entire compound used to introduce the metals into the compositions.

### DETAILED DESCRIPTION OF THE INVENTION

The present invention relates to malt-based or hops-based beverage products, which minimize the formation of off-flavors when subjected to sunlight or fluorescent light. These compositions include several required components including a hops-based or malt-based beverage base, and a stabilizing component which comprises a metal or a mixture of metals (present in the form of ions or metal compounds, complexes, oxides, chelates, or nonionic forms) with an adjunct component, such as ascorbic acid. These components, as well as optional additional components which may be included in the compositions of the present invention, are described below.

The basic component of the products of the present invention is a malt-based and/or hops-based beverage. These materials include, for example, beer, ale, light beer, malt liquor, lager, lambic, malted beverages (both alcoholic and nonalcoholic), malt coolers and malternatives. These products are well known and could be made by those skilled in the art. These products tend to form off-flavors when exposed to sunlight or fluorescent light and that is the issue which the present invention addresses.

In the beer-making process, malted barley grain is dried and crushed and mashed, and added to water. In this process, the starch in the grain turns to sugar. Hops is added to the solution and the solution is boiled. The solution is filtered to remove solids (e.g., excess hops); the remaining solution is called wort. The wort is cooled, yeast is added, and fermentation is carried out. During fermentation, the yeast converts the sugar in the solution into alcohol and carbon dioxide. Fermentation can take three to fourteen days to complete. The resulting product is filtered, carbon dioxide is added to carbonate the beverage, and the beer is placed in tanks or barrels and allowed to mature. Further details of the brewing process are taught in, for example, Bamforth, Beer—Tap into the Art and Science of Brewing, 2nd ed., 2003, Oxford University Press; Goldammer, The Brewer's Handbook, 2000, Apex Publishers; both of which are incorporated herein by reference.

The metals which may be used to stabilize the compositions and prevent the formation of off-flavors include zinc, magnesium, calcium, chromium, copper, iron, selenium, manganese, and mixtures thereof. Preferred metals include zinc, magnesium, calcium, copper, iron, manganese, and mixtures thereof. These metals are included in the compositions in their ionic form or as compounds, such as oxides; they may be introduced into the compositions in their oxide form or in the form of various salts, such as gluconates, ascorbates, citrates or lactates. For example, as used herein, “zinc” is intended to include any compound containing zinc, including a salt, complex, or other form of zinc. Acceptable forms of zinc are well known in the art. The zinc which can be used in the present invention can be in any commonly used forms such as, e.g., zinc lactate, zinc sulfate, zinc chloride, zinc acetate, zinc gluconate, zinc ascorbate, zinc citrate, zinc aspartate, zinc picolinate, amino acid chelated zinc, and zinc oxide. Zinc oxide and zinc gluconate are preferred ways of introducing zinc into the compositions of the present invention. The other metal ions listed above may be introduced into the compositions of the present invention in their salt or oxide or complex forms as described above for zinc. The metals may be used alone or in mixtures with each other.

When zinc oxide is used as the source for zinc, the zinc oxide is included in the compositions at levels of from about 0.0002% to about 0.5%, preferably from about 0.0004% to about 0.05% (based on the amount of the oxide included). Magnesium oxide, magnesium phosphate tribasic pentahydrate, magnesium carbonate, magnesium gluconate, magnesium ascorbate, and magnesium malate are included in the compositions, when used, at levels of from about 0.0005% to about 0.2%, and is preferably used at levels from about 0.0007% to about 0.05%. Calcium salts, such as calcium oxide, calcium lactate, calcium hydroxide, or calcium chloride, can be used in the compositions at levels of from about 0.05% to about 0.75%, preferably from about 0.0075% to about 0.5%. Zinc, magnesium and manganese are preferred metals for use in the present invention, with zinc and manganese being particularly preferred.

The adjunct stabilization components used in the present invention include ascorbic acid, sugar alcohols, erythorbic acid, ascorbates, erythorbates, and mixtures thereof. Thus, for example, sodium erythorbate or ascorbyl palmitate may be used in place of erythorbic acid or ascorbic acid. Sugar alcohols (polyols) are well known in the art and are derived from sugar molecules. They include, for example, sorbitol, mannitol, xylitol, lactitol, maltitol, isomalt, hydrogenated starch hydrolysates, erythritol, inulin, galactitol, inositol, ribitol, dithioerythritol, dithiothreitol, and glycerol. Mannitol, inositol, xylitol, and erythritol are preferred sugar alcohols for use in the present invention. A preferred adjunct material is ascorbic acid. When used, ascorbic or erythorbic acid or their acid salts are present in the compositions at from about 0.01% to about 0.3%, preferably from about 0.02% to about 0.15%. Mixtures of adjunct materials may be used in the compositions of the present invention. Preferred are mixtures of metals (in the form of ions, salts, oxides, complexes, chelates, or nonionic forms) with adjunct materials. Particularly preferred are mixtures of magnesium, manganese and/or zinc (in the form of ions, salts, oxides, complexes, chelates, or nonionic forms) together with ascorbic acid. In such mixtures, the zinc, manganese and/or magnesium are each typically used at levels of from about 0.0004% to about 0.03%; and the ascorbic acid is used at levels of from about 0.02% to about 0.15%, preferably from about 0.02% to about 0.08%.

Exemplary compositions of the present invention include a metal selected from: from about 0.0013% to about 0.34% magnesium, from about 0.000013% to about 0.0034% manganese, from about 0.000025% to about 0.0031% iron (ferrous or ferric), from about 0.0000048% to about 0.00048% copper, from about 0.0065% to about 0.65% calcium, from about 0.00037% to about 0.037% zinc, and combinations thereof; and an adjunct compound selected from 0.01% to about 1% sugar alcohol, from about 0.001% to about 0.2% ascorbic acid, and combinations thereof.

Sources of magnesium include, for example, magnesium oxide, magnesium carbonate, magnesium citrate, magnesium gluconate, magnesium ascorbate, magnesium malate, magnesium lactate, magnesium succinate, magnesium hydroxide, magnesium chloride, magnesium stearate, magnesium sulfate, magnesium phosphate, and combinations thereof. Preferred materials include magnesium oxide, magnesium carbonate, magnesium ascorbate, magnesium malate, magnesium phosphate, and combinations thereof. Of course, other sources may be used for magnesium, and for the other metals described below.

Sources of manganese include, for example, manganese gluconate, manganese ascorbate, manganese lactate, manganese sulfate, manganese carbonate, manganese oxide, manganese chloride, manganese citrate, and combinations thereof. Preferred materials include manganese gluconate, manganese sulfate, manganese citrate, and combinations thereof.

Sugar alcohols useful in the present invention include, for example, mannitol, inositol, erythritol, xylitol, sorbitol, lactitol, maltitol, isomalt, hydrogenated starch hydrolysates, inulin, galactitol, ribitol, dithioerythritol, dithiothreitol, glycerol, and combinations thereof. Inositol, xylitol, mannitol and/or erythritol are preferred.

Sources of iron for use in the present invention include, for example, ferric ammonium citrate, ferric chloride, ferric phosphate, ferric sulfate, ferrous ascorbate, ferrous carbonate, ferrous sulfate, ferrous gluconate, ferrous lactate, ferrous fumarate, and combinations thereof. Preferred materials include ferric ammonium citrate, ferrous gluconate and/or ferrous sulfate.

Sources of copper for use in the present invention include, for example, copper citrate, copper acetate, copper sulfate, copper gluconate, and combinations thereof. Copper gluconate is preferred.

Sources of calcium for use in the present invention include, for example, calcium lactate, calcium citrate, calcium sulfate, calcium hydroxide, calcium carbonate, calcium acetate, calcium gluconate, calcium oxide, calcium proprionate, calcium stearate, calcium chloride, and combinations thereof. Calcium lactate and/or calcium citrate are preferred.

Sources of zinc for use in the present invention include, for example, zinc oxide, zinc lactate, zinc citrate, zinc picolinate, zinc sulfate, zinc chloride, zinc stearate, zinc gluconate, and combinations thereof. Zinc oxide and/or zinc gluconate are preferred.

When certain stabilizing components are included in the compositions of the present invention, particularly when they are included at high levels, flavor-masking components can be added to mask any off-flavors which accompany the use of those stabilizing adjunct materials. For example, the use of very high levels of ascorbic acid or iron can result in off-flavors to the composition. Flavor-masking ingredients are well known in the art and include, for example, vanilla extracts, licorice extracts, glycyrrhizin, thaumatin, and mixtures of those materials. Such flavor-masking components are, for example, described in Modifying Bitterness: Mechanism, Ingredients and Applications, edited by G. Roy, Technomic Publishing Company, Inc., 1997, Lancaster, Pa., incorporated herein by reference.

The compositions of the present invention may also include other components conventionally known and used in beverage products. Examples of such materials include, for example, flavoring agents, coloring agents, preservatives, emulsifiers, carbonation components, and other safe and compatible components.

One or more flavoring agents may be used in the compositions of the present invention in order to enhance their palatability. This is particularly useful in malternative beverages such as, for example, hard lemonade or hard apple cider. Any natural or synthetic flavoring agent can be used in the present invention, as long as it is safe for consumption and compatible with the other components in the composition. For example, one or more botanical and/or fruit flavors may be utilized. Such flavors may be synthetic or natural flavors. Particularly preferred fruit flavors are exotic and lactonic flavors such as, for example, passion fruit flavors, mango flavors, pineapple flavors, cupuacu flavors, guava flavors, cocoa flavors, papaya flavors, peach flavors, and apricot flavors. Besides these flavors, a variety of other fruit flavors can be utilized, such as, for example, apple flavors, citrus flavors, grape flavors, raspberry flavors, cranberry flavors, cherry flavors, grapefruit flavors, and the like. These fruit flavors can be derived from natural sources such as fruit juices and flavor oils, or may alternatively be synthetically prepared.

Preferred botanical flavors include, for example, tea (for example, black, white, red, oolong and green tea), aloe vera, guarana, ginseng, gingko, hawthorn, hibiscus, rosehips, chamomile, peppermint, fennel, ginger, licorice, lotus seed, schizandra, saw palmetto, sarsaparilla, safflower, St. John's wort, curcuma, cardamom, nutmeg, cassia bark, buchu, cinnamon, jasmine, haw, chrysanthemum, water chestnut, sugar cane, lychee, bamboo shoots, vanilla, coffee, and the like. Preferred among these are tea, guarana, ginseng, gingko, and coffee. The flavor agents can also comprise a blend of various flavors. “Ice cream” flavors, such as vanilla, chocolate, strawberry, mocha and mint, to name a few, may also be used.

Small amounts of one or more coloring agents may be utilized in the compositions of the present invention. FD&C dyes (e.g., yellow no. 5, blue no. 2, red no. 40) and/or FD&C lakes are preferably used. Additionally, a mixture of FD&C dyes or FD&C lake dye in combination with other conventional food and food colorants may be used. Riboflavin and beta carotene may also be used. Additionally, other natural coloring agents may be used including, for example, fruit, vegetable, and/or plant extracts such as grape, black currant, aronia, carrot, beet root, red cabbage, hibiscus, anthocyanins, betalins, turmeric, curcumin, annatto, carotenoids, cochineal, carminic acid, and carmine. The amount of coloring agent used will vary, depending on the identity of the agents used and the intensity of color desired in the finished product. These materials are used at their conventional art-established levels.

Preservatives may or may not be needed for use in the present compositions. Techniques such as aseptic, hot fill, tunnel pasteurization, ultrahigh temperature (UHT) retort, and/or clean fill processing may be utilized to avoid the need for preservatives. One or more preservatives may, however, optionally be added to the present compositions at their art-established levels. Preferred preservatives include, for example, sorbate, benzoate, and polyphosphate preservatives (for example, sodium hexametapolyphosphate).

Carbon dioxide can be introduced into the beverages of the present invention to achieve carbonation. The carbonated beverage can be placed into a container, such as a bottle or can, and then sealed. Any conventional carbonation methodology may be utilized to make carbonated beverage compositions of the present invention. The amount of carbon dioxide introduced into the beverage will depend upon the particular flavor system utilized and the amount of carbonation desired.

The compositions of the present invention typically have a pH between about 2.5 and about 8.0. The pH may be adjusted by manipulation of the component levels (e.g., lactic acid or phosphates).

The present compositions can be made by conventional processes known in the art. The mixture of metals (in the form of ions/salts, oxides, complexes, chelates, or nonionic forms) and adjunct stabilization components can be made from a blend of the powder form of these components. Preferably, the powders will be of similar particle size to facilitate a homogeneous blend. This blend can, in turn, be mixed with powdered flavor and/or other powders present in the product to aid in the processing of the finished product. The mixture of metal components (in the form of ions/salts, oxides, complexes, chelates or nonionic forms) and adjunct stabilization components can be added directly during processing to the finished product as individual components.

The following are nonlimiting examples of compositions of the present invention. The compositions are prepared utilizing conventional methods. The following examples are provided to illustrate the invention and are not intended to limit the scope thereof in any manner.

### EXAMPLES

Using the manufacturing procedure described above, the following compositions are made. They can be tested using a procedure as follows. After the pasteurization step, the finished beverage is kept in one of three storage conditions for evaluation: control (refrigerated, no light exposure); refrigerated (approximately 45° F.) fluorescent light box (minimum five days before evaluation); and light box (ten hours, sunlight tester, Atlas Suntest, Model XLS+, manufactured by Atlas Material Testing Technology, LLC, Chicago, Ill.).

Coded samples are evaluated blindly by a trained panel of at least five persons in a modified ranking. Six to eight samples are included in each tasting session. A coded, nonstabilized “control” sample is also included in each session. Samples kept in the dark are tasted and compared to light-exposed samples. The test can continue for various lengths of time (e.g., 10 hours, seven days, two weeks, one month, two months). The tasters rank the samples “1” to “8” (for eight samples) or “1” to “6” (for six samples), with “1” being the best and “8” (or “6“) being the worst. All rankings are added together to give a combined ranking score for each sample. Lower rankings than the control ranking are considered improvements.

The malt base used in these examples is nonalcoholic and is made by the following procedure:
The barley is steeped for about three days and moisture increased to 43%. The steeped grains are then drained and allowed to germinate for 7-10 days at fairly low temperature. Small rootles grow beneath the husk. when the growth has reached between three-quarters and full length of the grain, germination is stopped by “kilning,” i.e., drying out the grains by heating. Malt before kilning is known as green malt. Kilning is carefully controlled, removing moisture to a relatively low level without destroying excessive amounts of enzymes but imparting characteristic flavor and color. It is used as the base malt in most ale mashes and can comprise up to 100% of total grist.

An alcohol-containing malt based beverage can be made by adding a fermentation step to the above procedure.

### Example 1

| Ingredient | % |
|---|---|
| Malt Base | 8.0 |
| Magnesium Ascorbate | 0.268 |
| Manganese Gluconate Dihydrate | 0.00294 |
| Erythritol | 0.1 |
| Water | Balance to 100 |

The products are made as follows:
Malt base is placed into the bottle with minerals and sugar alcohols. Carbonated water is added to make the final beverage and the bottle is capped off.

### Example 2

| Ingredient | % |
|---|---|
| Malt Base | 8.0 |
| Ascorbic Acid, Anhydrous | 0.02 |
| Magnesium Phosphate Tribasic Pentahydrate | 0.1648 |
| Manganese Gluconate Dihydrate | 0.00294 |
| Ferrous Gluconate | 0.002012 |
| Water | Balance to 100 |

### Example 3

| Ingredient | % |
|---|---|
| Malt Base | 8.0 |
| Ascorbic Acid, Anhydrous | 0.02 |
| Magnesium Phosphate Tribasic Pentahydrate | 0.1648 |
| Manganese Gluconate Dihydrate | 0.00294 |
| Inositol | 0.1 |
| Ferrous Gluconate | 0.002012 |
| Water | Balance to 100 |

### Example 4

| Ingredient | % |
|---|---|
| Malt Base | 8.0 |
| Ascorbic Acid, Anhydrous | 0.02 |
| Magnesium Carbonate | 0.0504 |
| Inositol | 0.1 |
| Ferrous Gluconate | 0.002012 |
| Water | Balance to 100 |

### Example 5

| Ingredient | % |
|---|---|
| Ascorbic Acid, Anhydrous | 0.02 |
| Magnesium Carbonate | 0.0504 |
| Manganese Sulfate Monohydrate | 0.0008272 |
| Inositol | 0.1 |
| Ferrous Gluconate | 0.002012 |
| HEINEKEN ® Beer | Balance to 100 |

### Example 6

| Ingredient | % |
|---|---|
| Ascorbic Acid, Anhydrous | 0.02 |
| Magnesium Oxide | 0.021 |
| Manganese Citrate | 0.001314 |
| Inositol | 0.1 |
| Zinc Gluconate | 0.0276 |
| Bud Light | Balance to 100 |

### Example 7

| Ingredient | % |
|---|---|
| Natural Flavor | 0.0001 |
| Ascorbic Acid, Anhydrous | 0.02 |
| Magnesium Oxide | 0.021 |
| Manganese Citrate | 0.001314 |
| Zinc Gluconate | 0.0276 |
| Bud Light | Balance to 100 |

### Example 8

| Ingredient | % |
|---|---|
| Natural Flavor | 0.0001 |
| Inositol | 1.0 |
| Magnesium Oxide | 0.021 |
| Manganese Citrate | 0.001314 |
| Zinc Gluconate | 0.0276 |
| Bud Light | Balance to 100 |

### Example 9

| Ingredient | % |
|---|---|
| Natural Flavor | 0.0001 |
| Ascorbic Acid, Anhydrous | 0.02 |
| Inositol | 1.0 |
| Magnesium Oxide | 0.021 |
| Manganese Citrate | 0.001314 |
| Zinc Gluconate | 0.0276 |
| Bud Light | Balance to 100 |

What is claimed is:

1. A malt-based or hops-based beverage product comprising:
(a) a hops-based or malt-based beverage base; and
(b) a stabilizing mixture comprising:
(i) from about 0.000001% to about 0.2% of a metal, in the form of ions, salts, oxides, complexes, chelates or nonionic forms, selected from zinc, magnesium, calcium, chromium, copper, iron, selenium, manganese, and combinations thereof; and
(ii) from about 0.01% to about 2.5% of an adjunct component selected from ascorbic acid, erythorbic acid, sugar alcohols, ascorbates, erythorbates, and combinations thereof.

2. The beverage product according to claim 2 wherein the beverage is selected from beer, ale, light beer, malt liquor, lager, lambic, alcoholic malted beverages, nonalcoholic malted beverages, malt coolers, and malternatives.

3. The beverage product according to claim 2 wherein the adjunct component comprises ascorbic acid, an ascorbate, erythorbic acid, an erythorbate, or combinations thereof.

4. The beverage product according to claim 2 wherein the metal comprises zinc, magnesium, manganese, iron, and combinations thereof.

5. The beverage product according to claim 3 wherein the metal is selected from zinc, magnesium, manganese, iron, and combinations thereof.

6. The beverage product according to claim 3 which additionally contains an effective amount of a flavor-masking component.

7. The beverage product according to claim 1 wherein the adjunct component comprises a sugar alcohol selected from mannitol, inositol, erythritol, xylitol, sorbitol, lactitol, maltitol, isomalt, hydrogenated starch hydrolysates, inulin, galactitol, ribitol, dithioerythritol, dithiothreitol, glycerol, and combinations thereof.

8. The beverage product according to claim 4 wherein the adjunct component comprises a sugar alcohol selected from mannitol, inositol, erythritol, xylitol, sorbitol, lactitol, maltitol, isomalt, hydrogenated starch hydrolysates, inulin, galactitol, ribitol, dithioerythritol, dithiothreitol, glycerol, and combinations thereof.

9. The beverage product according to claim 1 wherein the metal is selected from zinc, magnesium, calcium, copper, iron, manganese, and combinations thereof.

10. The beverage product according to claim 1 which contains a metal selected from: from about 0.0013% to about 0.34% magnesium, from about 0.000013% to about 0.0034% manganese, from about 0.000025% to about 0.0031% iron (ferrous or ferric), from about 0.0000048% to about 0.00048% copper, from about 0.0065% to about 0.65% calcium, from about 0.00037% to about 0.037% zinc, and combinations thereof; and an adjunct component selected from 0.01% to about 1% sugar alcohol, from about 0.001% to about 0.2% ascorbic acid, and combinations thereof.

11. The beverage product according to claim 10 wherein the metal is magnesium which is added to the product in the form of a material selected from magnesium oxide, magnesium carbonate, magnesium citrate, magnesium gluconate, magnesium ascorbate, magnesium malate, magnesium lactate, magnesium succinate, magnesium hydroxide, magnesium chloride, magnesium stearate, magnesium sulfate, magnesium phosphate, and combinations thereof.

12. The beverage product according to claim 11 wherein the magnesium is added to the product in the form of a material selected from magnesium oxide, magnesium carbonate, magnesium ascorbate, magnesium malate, magnesium phosphate, and combinations thereof.

13. The beverage product according to claim 10 wherein the metal is manganese which is added to the product in the form of a material selected from manganese gluconate, manganese ascorbate, manganese lactate, manganese sulfate, manganese carbonate, manganese oxide, manganese chloride, manganese citrate, and combinations thereof.

14. The beverage product according to claim 13 wherein the manganese is added to the product in the form of a material selected from manganese gluconate, manganese sulfate, manganese citrate, and combinations thereof.

15. The beverage product according to claim 10 wherein the adjunct material is a sugar alcohol which is added to the product in the form of a material selected from mannitol, inositol, erythritol, xylitol, sorbitol, lactitol, maltitol, isomalt, hydrogenated starch hydrolysates, inulin, galactitol, ribitol, dithioerythritol, dithiothreitol, glycerol, and combinations thereof.

16. The beverage product according to claim 15 wherein the sugar alcohol is added to the product in the form of a material selected from inositol, xylitol, mannitol, erythritol, and combinations thereof.

17. The beverage product according to claim 10 wherein the metal is iron which is added to the product in the form of a material selected from ferric ammonium citrate, ferric chloride, ferric phosphate, ferric sulfate, ferrous ascorbate, ferrous carbonate, ferrous sulfate, ferrous gluconate, ferrous lactate, ferrous fumarate, and combinations thereof.

18. The beverage product according to claim 17 wherein the iron is added to the product in the form of a material selected from ferric ammonium citrate, ferrous gluconate, ferrous lactate, and combinations thereof.

19. The beverage product according to claim 10 wherein the metal is copper which is added to the product in the form of a material selected from copper citrate, copper acetate, copper sulfate, copper gluconate, and combinations thereof.

20. The beverage product according to claim 19 wherein the copper is added to the product in the form of copper gluconate.

21. The beverage product according to claim 10 wherein the metal is calcium which is added to the product in the form of a material selected from calcium lactate, calcium citrate, calcium sulfate, calcium hydroxide, calcium carbonate, calcium acetate, calcium gluconate, calcium oxide, calcium proprionate, calcium stearate, calcium chloride, and combinations thereof.

22. The beverage product according to claim 21 wherein the calcium is added to the product in the form of a material selected from calcium lactate, calcium citrate, and combinations thereof.

23. The beverage product according to claim 10 wherein the metal is zinc which is added to the product in the form of a material selected from zinc oxide, zinc lactate, zinc citrate, zinc picolinate, zinc sulfate, zinc chloride, zinc stearate, zinc gluconate, and combinations thereof.

24. The beverage product according to claim 23 wherein the zinc is added to the product in the form of a material selected from zinc oxide, zinc gluconate, and combinations thereof.

25. The beverage product according to claim 2 in the form of a beer.

26. The beverage product according to claim 25 wherein the adjunct component comprises a material selected from ascorbic acid, an ascorbate, or combinations thereof.

27. The beverage product according to claim 25 wherein the metal comprises a material selected from magnesium, zinc, manganese, iron, and combinations thereof.

28. The beverage product according to claim 25 which additionally contains an effective amount of a flavor-masking component.

29. The beverage product according to claim 25 wherein the adjunct component comprises a sugar alcohol selected from mannitol, inositol, erythritol, xylitol, sorbitol, lactitol, maltitol, isomalt, hydrogenated starch hydrolysates, inulin, galactitol, ribitol, dithioerythritol, dithiothreitol, glycerol, and combinations thereof.

30. The beverage product according to claim 25 which contains a metal selected from: from about 0.0013% to about 0.34% magnesium, from about 0.00003% to about 0.003% manganese, from about 0.0000025% to about 0.00025% iron (ferrous or ferric), from about 0.0065% to about 0.65% calcium, from about 0.00039% to about 0.039% zinc, and combinations thereof; and an adjunct component selected from 0.1% to about 10% sugar alcohol, from about 0.001% to about 0.2% ascorbic acid, and combinations thereof.

31. The beverage product according to claim 30 wherein the metal is magnesium and is added to the product in the form of a material selected from magnesium oxide, magnesium carbonate, magnesium phosphate, and combinations thereof.

32. The beverage product according to claim 30 wherein the metal is manganese and is added to the product in the form of a material selected from manganese gluconate, manganese citrate, and combinations thereof.

33. The beverage product according to claim 30 wherein the adjunct component is sugar alcohol and is added to the product in the form of inositol.

34. The beverage product according to claim 30 wherein the metal is iron and is added to the product in the form of ferrous gluconate.

35. The beverage product according to claim 30 wherein the metal is calcium and is added to the product in the form of calcium citrate.

36. The beverage product according to claim 30 wherein the metal is zinc and is added to the product in the form of a material selected from zinc oxide, zinc gluconate, and combinations thereof.

37. The beverage product according to claim 1 which comprises from about 0.000001% to about 0.1% of the metal, and from about 0.01% to about 1.5% of the adjunct component.

38. A malt-based or hops-based beverage product comprising:
(a) a hops-based or malt-based beverage base; and
(b) from about 0.000001% to about 0.2% of metal in the form of ions, salts, oxides, complexes, chelates or nonionic forms, selected from zinc, magnesium, calcium, copper, iron, manganese, and combinations thereof.
